(19) United States
(12) Patent Application Publication
(10) Pub. No.: US 2008/0217093 A1
(43) Pub. Date: Sep. 11, 2008

(54) Adjustable track tractor for zero compaction farming

(76) Inventor: William John Foxwell, Troy, MI (US)

Correspondence Address: JOHN R. BENEFIEL, 525 Lewis Street, BIRMINGHAM, MI, 48009, US

(21) Appl. No.: 12/074,544

(22) Filed: Mar. 4, 2008

Related U.S. Application Data
(60) Provisional application No. 60/904,907, filed on Mar. 5, 2007.

(51) Int. Cl. B62D 49/00

(52) U.S. Cl. 180/340

(57) ABSTRACT

An adjustable track tractor formed by a control and slave drive unit connected together at their front and rear ends with respective front and rear cross beams pivoted at each end thereto. Each drive unit is converted from a conventional tractor to have only a single front and rear wheel. When the cross beams are pivoted by rotary hydraulic actuators, the drive units are moved together or apart to change the wheel track.

### CROSS REFERNCE TO RELATED APPLICATION

This application claims the benefit of U.S. provisional application Ser. No. 60/904,907 filed on Mar. 5, 2007.

### BACKGROUND OF THE INVENTION

This invention concerns wide track tractors which are adjustable in width. Since the early 80's in Australia 5 million acres of grain crops are under production where the high powered tractors, large combines and heavy trucks all have the same track settings of either 2 or 3 m so that they operate on controlled pathways centered 2 or 3 m apart. This is called “Controlled Traffic Farming” [CTF]. The 3 m setting is becoming the standard. In the field the 3 m tracks are centrally spaced 9 m apart and the combine and planters are 9 m wide with the chemical booms 27 m wide. The advantages are that the tractor can be less powerful because the wheels run on packed soil, minimum or no tilling of the soil is needed, neither is there any need to subsoil every few years, water penetration is better, there are no ruts or ridges left over from previous operations, the fuel saved is substantial and the crops are much larger because of the zero compaction. Further explanation, in detail with the cost savings, can be obtained on the internet sit [www.controlledtrafficfarming.com] and the ASABE papers noted in the references.

The small farmer could benefit from CTF in the small scale production of vegetables, fruit, nuts, flowers, seeds and bulbs, etc. but existing equipment is too large and expensive.

A tractor for small scale CTF should be low powered, no higher than 40 kW and should use as many production parts as possible from current conventional tractors to keep the price low. It should be easily adjusted from the tractor seat for road use between the plots and vice versa. It should not be too wide in order to enable the Cat.11 3 point hitch to handle many mounted implements already in use. A maximum width of the soil between the tracks of 3.66 m should be satisfactory with a wheel track setting of 4.27 m.

The object of the present invention is to provide a low cost efficient tractor for small scale controlled traffic forming.

### SUMMARY OF THE INVENTION

The above recited object of the invention and other objects which will become apparent upon a reading of the following specification and claims are achieved by a tractor comprised of two separated but interconnected units, a master or control unit and a slave unit each unit driving its own single main rear wheel.

The control unit is basically the same as a typical production tractor consisting of an engine, transmission, rear axle assembly and sheet metal etc. It has one front wheel and one rear driving wheel removed including the fender, axle shaft, bell housing, planetary driving gear set, differential gears, differential lock and brake. A means is provided to connect the remaining planetary gear set to the differential housing in order to drive the remaining rear wheel and a cast plate replaces the bell housing and holds the bearing cup which supports the differential housing. The hydraulic lift housing is also removed. Both the PTO and the drawbar are retained.

The slave unit consists of a transmission and a rear axle assembly which drives only one rear wheel of the opposite hand of the one in the control unit. The PTO and the hydraulic lift are not required. The drawbar is retained. It also only has one front wheel, of the opposite hand to the one on the control tractor and it is rigidly supported by side channels extending forward from the transmission housing, which also carry ballast weights to make the slave drive unit equal in weight with the control unit.

Single front wheels can be used because they run on packed soil making front wheel assist drives unnecessary. They also are easier to turn through greater angles when Helac™ hydraulic rotary actuators [www.helac.com] are used controlled with a steering wheel. Freely mounted caster wheels can be used if the transmissions are used for steering with control levers similar to that of a zero-turn lawn tractor.

The transmission in the control unit is either a hydraulic unit with one or more pumps and motors or an electric transmission with one or more generators and motors. The transmissions must be able to share the engine power equally between the control unit and the slave unit. The transmission in the slave unit has either hydraulic or electrical motors driven from the control unit through hydraulic hoses or electric cables depending on the nature of the transmissions.

The control unit and the slave unit are joined together with a cross beam at their rear ends and a smaller cross beam at their front ends. The rear beam has horizontal pivots at both ends to allow the two units to articulate with each other on uneven ground and vertical pivots to enable the beam to turn through 90 degrees, in the plan view, when changing the track from the field position to the road position and vice versa. The vertical pivots are integrated with Helac™ hydraulic rotary actuators [www.helac.com] which assist when the track is changed and which locks the beam rigidly in position in both the field and road positions.

The horizontal pivots can be connected to the control unit and the slave unit with sleeves which allow the beam to be lowered into position onto two half bearing blocks attached to a plate which is bolted to the opening on top of each rear axle housing, formally covered by the hydraulic lifts, and then held in place with two half bearing caps. The horizontal pivots are spring loaded against the outer ends of the sleeves longitudinally in order to keep the lower plate, which has a circular end attached to the rear cross beam, firmly in contact with the mating circular cut-out attached to each rear axle housing. This arrangement keeps the two driving units in an upright position, with each other, when the track is being changed and also allows the two units to articulate with each other in the road position.

The front cross beam is attached to each driving unit with vertical and horizontal pivots to allow for articulation and to maintain them parallel to each other when the beam is rotated 90 degrees to change the track. The front beam also reacts to vertical loads at its center from a torque arm attached to the rear cross beam which transmits the torque from an implement attached to the 3 pt. hitch evenly between each drive unit. The 3 pt. hitch and drawbar are mounted on a steel plate bolted to the rear of the cross beam so that, in the field position, its front face makes contact with the rear end of the torque arm in order to make the torque arm and the rear cross beam revolve as one unit in the field position and to be no longer effective when rotated through 90 degrees in the road position allowing the arm to oscillate at its horizontal pivot on uneven ground.

To comply with the road regulations in different countries the control unit with the cab and the slave drive unit can be interchanged during manufacture. When the tractor is shipped from the place of manufacture to the dealer or farmer the two cross beams and the torque arm can be shipped separately and the control unit and the slave drive unit are connected together with a short round slave shaft allowing it to be driven onto a truck etc.

When the front wheels are steered with hydraulic actuators only the control tractor is used to drive and steer the tractor on the road. The rear axle on the slave unit is disconnected from the transmission and is free to turn, because there is no differential, and the front wheel on the slave drive unit is fixed in the straight ahead position. The track is a maximum of 2.69 m legally suitable for most roads.

Should the tractor be used permanently in the fields and never driven on a road the vertical pivots on the rear and front cross beams are not required as well as the hydraulic rotary cylinders which operate the rear cross beam. Should this situation arise the tractor would most likely use the transmissions for steering in the field with caster front wheels.

PTO driven implements are powered from the PTO drive on the control unit.

The method of construction of the tractor makes it easy to adapt existing designs of high clearance tractors should there be the need for such a vehicle.

Australians are making increasing use of satellite steering systems to set out the controlled tracks in the first place and to find the tracks when they are grown over each new seasons and to steer the machines automatically in work. While expensive this can pay off on the larger plots [www.controlledtrafficfarming.com].

When an implement is too heavy or large to be operated on the 3 pt. hitch, such as a harvesting wagon, it can be pulled by the tractor by attaching it to both drawbars of the two drive units and using caster wheels at each of its four corners to run on the controlled tracks. This makes the implement revolve with the tractor during turns in almost the same space as mounted equipment. For road use the trailer can be pulled from a hitch attached to one of its narrow sides.

### DESCRIPTION OF DRAWINGS

FIG. 1a is a plan view of an adjustable width wide track tractor according to the present invention running in tracks depicted with broken lines.

FIG. 1b is a rear view of the tractor shown in FIG. 1a depicting packed soil tracks and intervening untilled soil areas.

FIG. 1c is a left side elevational view of the tractor shown in FIGS. 1a and 1b.

FIG. 1d is a plan view of the tractor shown in FIG. 1a with the track adjusted to be of reduced width for road transport.

FIG. 1e is a side elevational view of the adjusted width track tractor shown in FIG. 1d.

FIG. 2a is an enlarged side elevational view of the tractor control with rear axle housing.

FIG. 2b is a rear view of the rear axle housing shown in FIG. 2a.

FIG. 2c is a top view of the rear axle housing shown in FIG. 2a and 2B.

FIG. 3a is a plan view of the rear cross beam horizontal pivots and rear axle housing slave included in the tractor according to the invention.

FIG. 3b is a front view of the components shown in FIG. 3a.

FIG. 3c is an end view of the rear cross beam and pivots shown in FIG. 3a.

FIG. 4a is a side elevational view of the rear portion of the tractor of FIG. 1a, showing a connector to the rear beam 16 with a point linkage and diameter.

FIG. 4b is a fragmentary rear view of the rear cross beam with components connecting the three point linkage and drawbar thereto.

FIG. 5a is a rear view of the front cross beam and fragmentary views of the front wheel supports and connecting clevis and clevis connection to the torque arm.

FIG. 5b is a plan view of the front cross arm and torque arm shown in FIG. 5a.

FIG. 5c is a side view of the torque arm clevis connection to the cross arm and pivot clevis on the plate connection to a rear cross beam.

FIG. 6 is a plan view of the tractor shown in FIG. 1a assembled for shipment.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

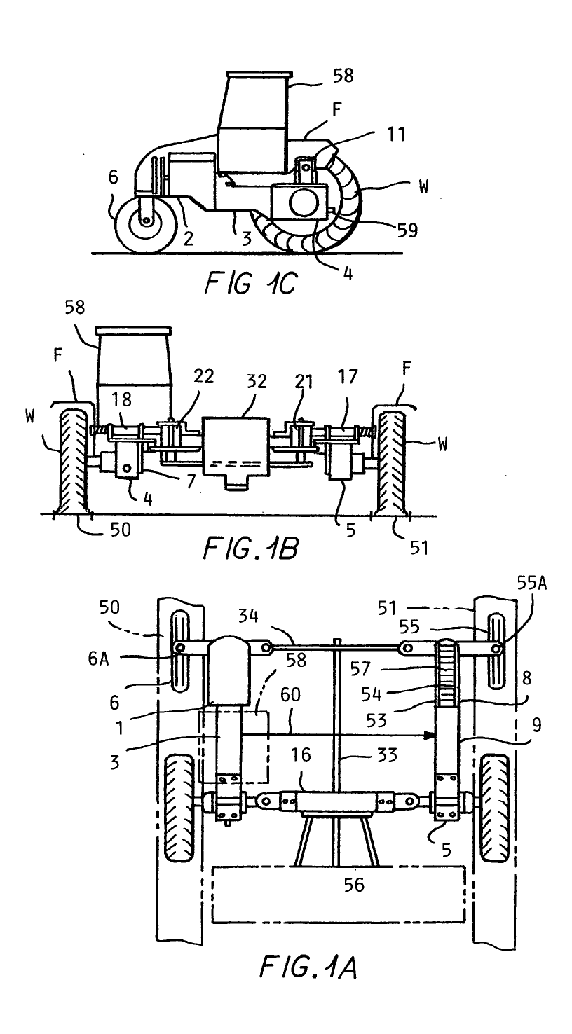

FIGS. 1a, b, and c show how a tractor according to the invention is configured for field work with rear drive wheels running on controlled tracks 50-51 and adjusted together (FIGS. 1d, e) for road travel between the fields.

It consists of a control unit 1 which has an engine 2 driving a hydrostatic or electric transmission 3 including a pump and motor (not shown) or a motor and generator (not shown) connected to a conventional double reduction rear axle assembly 4 which has several components removed including the inner driving wheel, axle, trumpet housing, differential gears, differential lock, planetary reduction gears, and disc brake. Also removed is the inner fender (leaving outer fender F), the 3 Pt. linkage components and the drawbar. The PTO is retained. A cast iron plate 7 replaces the trumpet housing and houses the bearing cup which supports the difference housing. A means is also provided to connect the remaining planetary gear set to the differential housing in order to drive the rear wheel. A cab 58 is attached to the control drive unit 1 in the conventional manner.

The inner front wheel is also discarded and the remaining front wheel 6 is rigidly attached to the front end of the control unit 1 and controlled for steering with a rotary actuator 6A (see www.helac.com for a description of a suitable rotary actuator).

A slave driving unit 8 is combined with the control drive unit 1 and does not have an engine. The hydrostatic or electrical transmission 9 is driven remotely from the control tractor 1 transmission 3 via fluid or electrical connections 60 depicted diagrammatically, and drives the rear axle 5 which has similar components removed as in the control unit 1 except that they are of the opposite hand. Also removed is the seat, steering wheel, platform, instrument panel, sheet metal, grille, pedals, controls, battery, radiator, fuel tank, etc.

Side channels 53 and 54 extend from the transmission housing 9 to support the front wheel 55 and ballast weights 57 are added to compensate for the absence of the engine and the other parts.

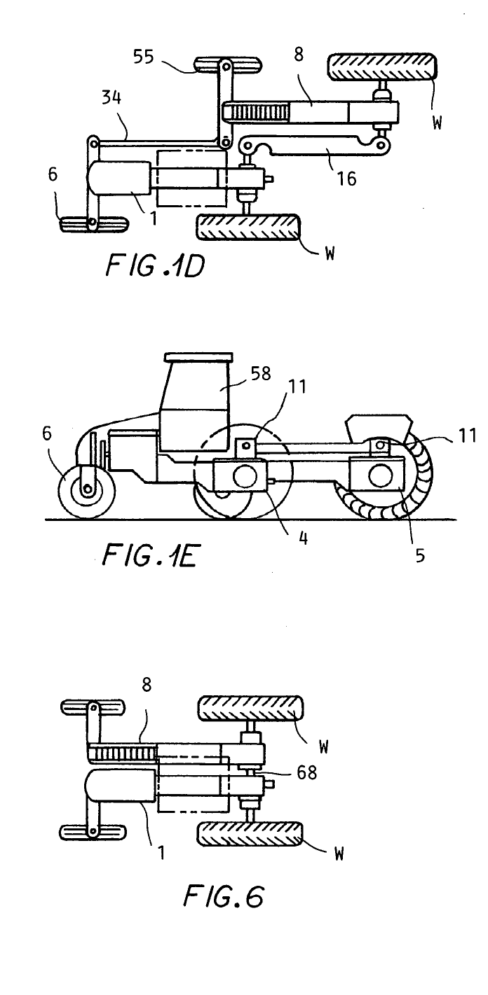

FIGS. 2a, b, & C are rear views of the control unit rear axle housing 4 and show the details as to how the control unit 1 is connected to the slave unit 8. The opening left vacant with the removal of the hydraulic power lift housing is covered with a steel plate or casting 10. Welded or cast to the new cover plate 10 are two half bearing blocks 11 and 12 which holds a hollow sleeve 13. It is also prevented from moving sideways. A similar arrangement of the sleeve 13 is also carried out on the slave unit 8.

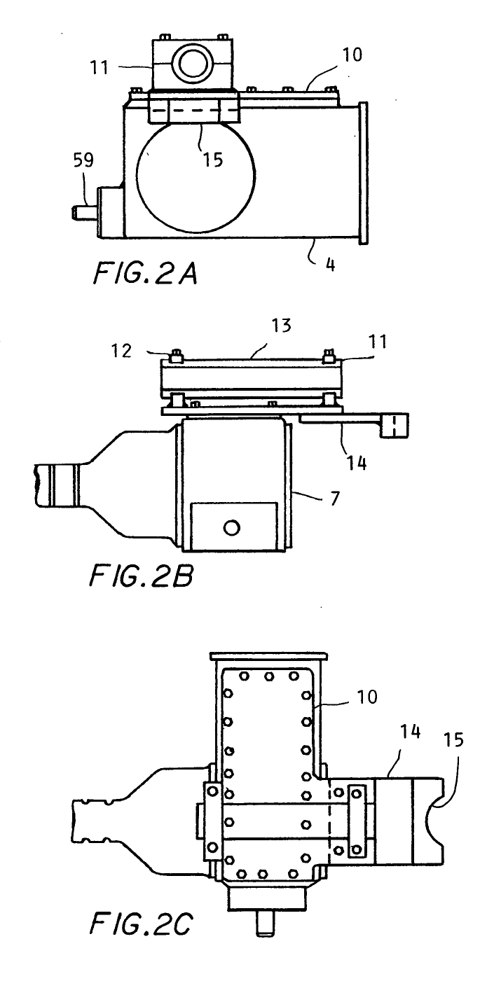

Also bolted to the underside of the plate 10 is a steel plate 14 containing a half circular cut-out 15 which connects with the rear cross beam 16 as shown in FIGS. 3a, b, and c.

FIGS. 3a, b & c. These show how the rear cross beam 16 is connected with horizontal pivots 17 and 18 to the rear axle housing sleeve 13.

The cross beam 16 is fabricated in a hollow rectangular form with two steel plates 19 and 20 bolted to it at each end which attach with splined vertical pivots 28 and 29 to rotary hydraulic actuators 21 and 22 similar to the rotary actuator 6A which are required to help in changing the tracks. The actuators 21 and 22 are attached to horizontal pivots 17 and 18 which run in the sleeves 13 and are spring loaded 23 to keep the round shaped plate 20 in contact with the half circle cut-out 15 in the steel plate 14 when the tractor is changing tracks. This keeps the control unit 1 and the slave unit 8 in vertical alignment with each other in the road position.

If the tractor is never to be operated on a road then the vertical pivots 28 and 29, the rotary actuators 21 and 22, and the springs 23 are not required as are the vertical pivots 35 and 36 attached to the front cross beam 34.

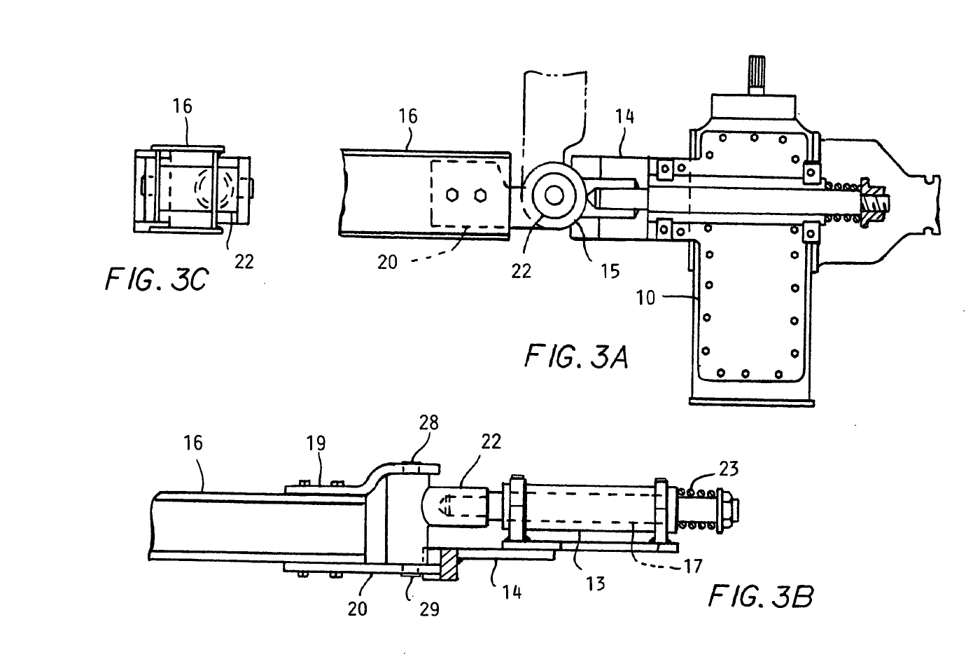

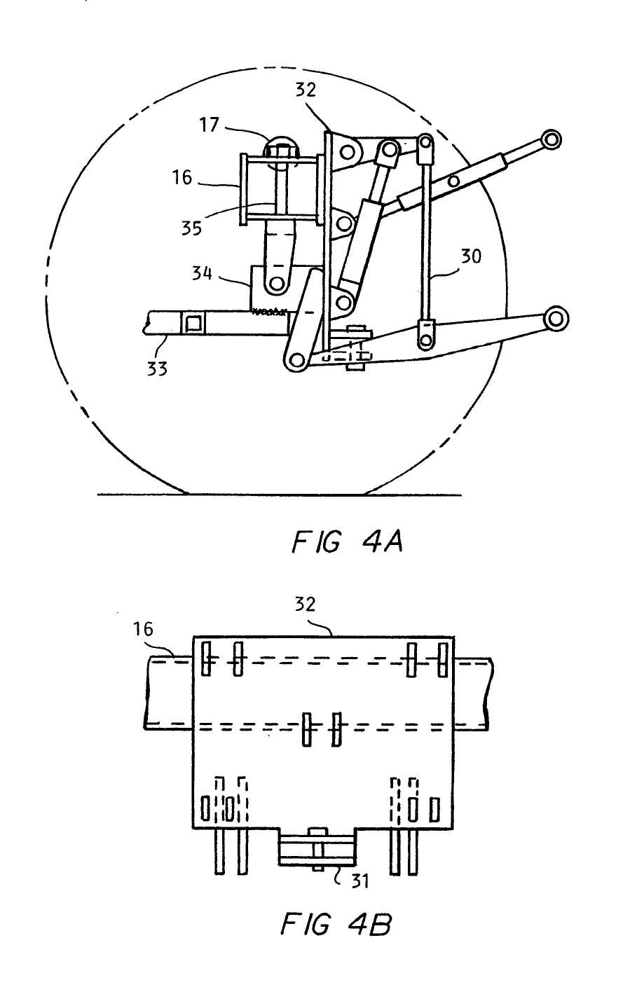

FIGS. 4a, b, & C show how the 3 point linkage 30 and drawbar 31 are attached to the rear cross beam 16 with a steel plate 32 and how the rear end of a torque arm 33, which is needed to resist the turning moments caused by an implement 56 about the horizontal pivots 17 and 18 on the rear cross beam 16, is connected to the cross beam 16. It is arranged so that, in the field position as shown, a steel plate 39 welded to the hollow square torque arm 33 makes contact with the plate 32 so that the loads on the front cross beam from the torque arm are always vertical (see FIG. 5). When the torque arm 33 is rotated 90 degrees when changing to the road position it is then free to oscillate on uneven ground.

FIGS. 5,a, b, & c show how the front cross beam 34 is attached with devises 36 and 37 to each drive units 1 an 8 and how the front end of the torque arm 33 is connected to it at its middle point by clevis 30 in order to balance out the loads equally between the two drive units 1 and 8 in the field position.

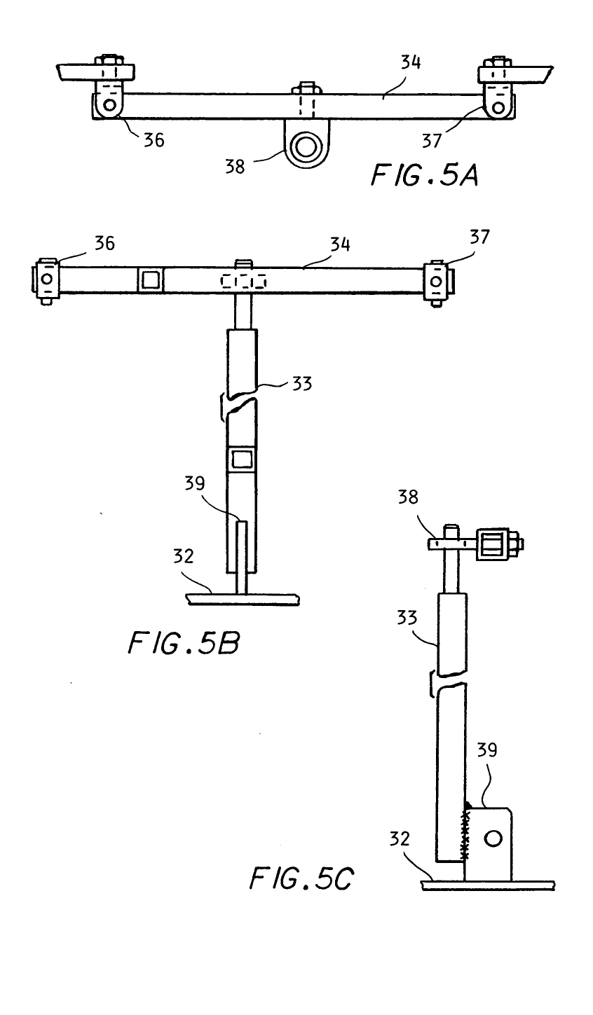

FIG. 6 shows how the tractor can be configured for shipping from the place of manufacture to the field. The long rear beam 16 and the long front beam 34 and the torque arm 33 are shipped separately. The two drive units 1 and 8 are connected with a short one-piece hollow shaft 68.

1. An adjustable width wide track tractor consisting of a master drive unit: and a slave drive unit each having only one front and rear wheel connected together with front and rear cross beams each pivotally connected and each end to rear and front ends respectively of said control and slave units and rotary actuators selectively operable to rotate said pivotal connections, laterally moving said control and slave drive units apart or together to enable the tractor to be operated both in the field and on the road and which in the field drive wheels are spaced far apart to run in controlled tracks to avoid compacting the soil between the tracks in order to improve plant growth, and when on the road said wheels are spaced more closely.

2 A wide track tractor corresponding to claim 1 wherein said control unit is a part of a conventional tractor except that it only has one rear driving wheel and one front wheel with an engine and transmission and said slave unit only has a transmission driven remotely by said control unit transmission.

3 A wide track tractor as according to claim 2 wherein said control unit transmission comprises a hydrostatic unit with an interconnected pump and fluid motor, and wherein said pump of said control unit transmission is connected to said slave unit transmission and has sufficient capacity to drive a motor in said slave unit transmission.

4. The wide track tractor according to claim 2 wherein said control unit transmission comprises a generator and motor combination and wherein said control unit generator drives a motor in said slave unit transmission.

5. A wide track tractor according to claim 2 wherein conventional components which drove a removed rear wheel of a tractor from which said control unit is made are also removed including the axle shaft, trumpet housing, differential, differential lock, final drive planetary gears and steering brake, said trumpet housing replaced with a cast plate which on its inside houses a differential bearing cup formerly carried in the trumpet housing with means provided to connect a planetary gear set to a differential housing and a remaining front wheel is rigidly fixed to the front of the control drive unit.

6. A wide track tractor according to claim 1 wherein said slave drive unit includes a transmission housing containing a transmission driven from a transmission in said control drive unit and a rear axle assembly in said control unit and slave unit driving a respective rear wheel associated with each transmission.

7. A wide track tractor according to claim 5 where side members extend forward and are attached to said slave drive unit transmission housing supporting a single front wheel and has ballast weights bringing said slave drive unit to the same field weight as said control drive unit.

8. A wide track tractor according to claim 1 where the rear cross beam at its ends is attached to a rear end of both drive units with horizontal axis pivots which allows said two drive units to articulate with each other on uneven ground.

9. A wide track tractor according to claim 7 wherein said rear cross beam also has vertical axis pivots at each end which allows said beam to be rotated laterally to change the track of the wheels by moving said control and slave units together or apart.

10. A wide track tractor as claimed in claim 1 wherein vertical axis pivots are provided at each end of said cross beams, each integrated with a hydraulic rotary actuator which drives said pivots in changing said wheel tracks and which also locks said beams rigidly to said drive units in field and road positions respectively.

11. A wide track tractor as claimed in claim 1 wherein horizontal pivots are spring loaded against ends of sleeves longitudinally in order to keep a lower plate, attached to a rear cross beam, which has a circular end firmly seated with the mating circular cut-out attached to each rear axle housing in order to keep said two driving units in an upright, vertical position relative to each other when changing tracks and allow said drive units to articulate on uneven ground in the road position.

12. A wide track tractor according to claim 1 wherein said rear cross beam is attached to each drive unit with vertical and horizontal pivots to allow for articulation and to maintain them parallel with each other when changing the track when said rear beam pivots are rotated.

13. A wide track tractor according to claim 8 wherein said front cross beam reacts to vertical loads at its longitudinal center with a torque arm attached to said rear cross beam, which transmits torque from an implement attached to said rear cross beam about its horizontal pivots evenly between each drive unit.

14. A wide track tractor according to claim 14 wherein a 3 point hitch and drawbar are mounted to a steel plate bolted to a rear face of the rear cross beam so that in the field position its front face makes connect with the rear end of said torque arm in order to make said torque arm and the rear cross beam revolve as one unit in order to transmit vertical loads to said front cross beam from an implement.

15. A wide track tractor as in claim 14 wherein when the rear cross beam is rotated through 90 degrees laterally the connection between the rear end of the torque arm and the front face of the steel plate is no longer effective so allowing the torque arm to oscillate at its horizontal pivot in the road position on uneven ground.

16. A wide track tractor according to claim 1 wherein said front wheels are each steered with a hydraulic rotary actuator.

17. A wide track tractor according to claim 1 wherein said drive units can each be interchanged with each other in order to change the steering side.

18. A wide track tractor according to claim 13 which can be adapted for shipping from the place of manufacture by shipping said cross beams and torque arm separately and said drive units are connected with a short shaft.
